(19) United States
(12) Patent Application Publication
(10) Pub. No.: US 2015/0078612 A1
(43) Pub. Date: Mar. 19, 2015

(54) STRUCTURE OF SPEAKER DRIVER

(71) Applicants: Ching-Wen Yang, Taipei City (TW); FirstChair Acoustics Co., Ltd., Taipei City (TW)

(72) Inventor: Ching-Wen Yang, Taipei City (TW)

(73) Assignees: Ching-Wen Yang, Taipei City (TW); FirstChair Acoustics Co., Ltd., Taipei City (TW)

(21) Appl. No.: 14/188,948

(22) Filed: Feb. 25, 2014

(30) Foreign Application Priority Data
Sep. 17, 2013 (TW) 102217479

(51) Int. Cl. H04R 9/04

(52) U.S. Cl. CPC H04R 9/04; H04R 2209/022
USPC 381/414

(57) ABSTRACT

The present invention is to provide a structure of speaker driver, it comprising a base, a drum paper, a yoke, a sound coil and a magnetic unit. The base includes an upper combining portion and a lower combining portion. The drum paper is configured to the upper combining portion. The yoke is configured to the lower combining portion. The sound coil is configured to an underside of drum paper surroundingly. The magnetic unit has a magnet and a front plate, the magnetic unit is configured to above the yoke. Wherein an internal ring surface of yoke has a surface of first poly-magnet and a surface of second poly-magnet, the surface of first poly-magnet is closer to center of yoke than the internal ring surface, the surface of second poly-magnet rises along with the internal of yoke, a bottom of yoke also rises to correspond to the surface of second poly-magnet; an external ring surface of front piece is more distant from center of front piece than an external ring surface of magnet. The structure of speaker driver to gather magnetic lines for enhancing an intensity of magnetic field and reducing a loss of magnetic flux so as to prevent from magnetic leakage.

### FIELD OF THE INVENTION

The present invention relates to a structure of speaker driver, and particular to the structure of speaker driver enhances an intensity of magnetic field and reduces a loss of magnetic flux.

### BACKGROUND OF THE INVENTION

Traditionally, a shape of yoke of structure of speaker likes as basin, and a washer corresponds to a magnet to form an external ring surface. When the sound coil moves at vertical direct, since the structure does not gather magnetic lines, it results in phenomenon of magnetic leakage. The phenomenon destroys a sound generated from the speaker.

Taiwan Utility Model Patent No. M385181 discloses an improved speaker structure of magnetic path. The technical feature utilizes character of magnet to reduce magnetic leakage and enhances a magnetic flux density of magnetic gap. However, the above-mentioned patent does not teach and suggest the structure of present invention; the structure consists of the yoke and the washer. The above-mentioned patent also cannot reach the effect disclosed by the present invention.

Based on the deficiencies of the related art, the present invention provides a structure of speaker driver, the structure utilizes the yoke and the washer for enhancing an intensity of magnetic field and reducing a loss of magnetic flux so as to prevent a phenomenon of magnetic leakage.

### SUMMARY OF THE INVENTION

Based on the problems as disclosed above, an objective of the present invention is to provide an improved speaker structure to solve the deficiencies of the related arts.

An aspect of The present invention is to provide a structure of speaker driver, it comprising a base, a drum paper, a yoke, a sound coil and a magnetic unit. The base includes an upper combining portion and a lower combining portion. The drum paper is configured to the upper combining portion and the yoke is configured to the lower combining portion. The sound coil is configured to an underside of drum paper surroundingly. The magnetic unit includes a magnet and a front plate, the magnetic unit is configured to above the yoke. Wherein an internal ring surface of yoke has a surface of first poly-magnet and a surface of second poly-magnet, the surface of first poly-magnet is closer to center of yoke than the internal ring surface, the surface of second poly-magnet rises along with the internal of yoke, a bottom of yoke also correspondingly rises to the surface of second poly-magnet; an external ring surface of front piece is more distant from center of front piece than an external ring surface of magnet. Compare to a prior art, the present invention provides a structure of speaker driver to gather magnetic lines for enhancing an intensity of magnetic field and reducing a loss of magnetic flux so as to prevent a phenomenon of magnetic leakage.

### BRIEF DESCRIPTION OF THE DRAWING

FIG. 1 is a schematic view of a structure of speaker driver according to a preferred embodiment of the present invention;

FIG. 2 is schematic view of a structure of speaker driver according to a another preferred embodiment of the present invention;

FIG. 3 is schematic view of a structure of speaker driver according to another preferred embodiment of the present invention.

### DESCRIPTION OF EMBODIMENTS OF THE INVENTION

To understand the objectives, features and effects of the present invention, the following detailed description of the embodiment of the present invention is provided along with the accompanied drawings to further describe the present invention in greater detail as follows.

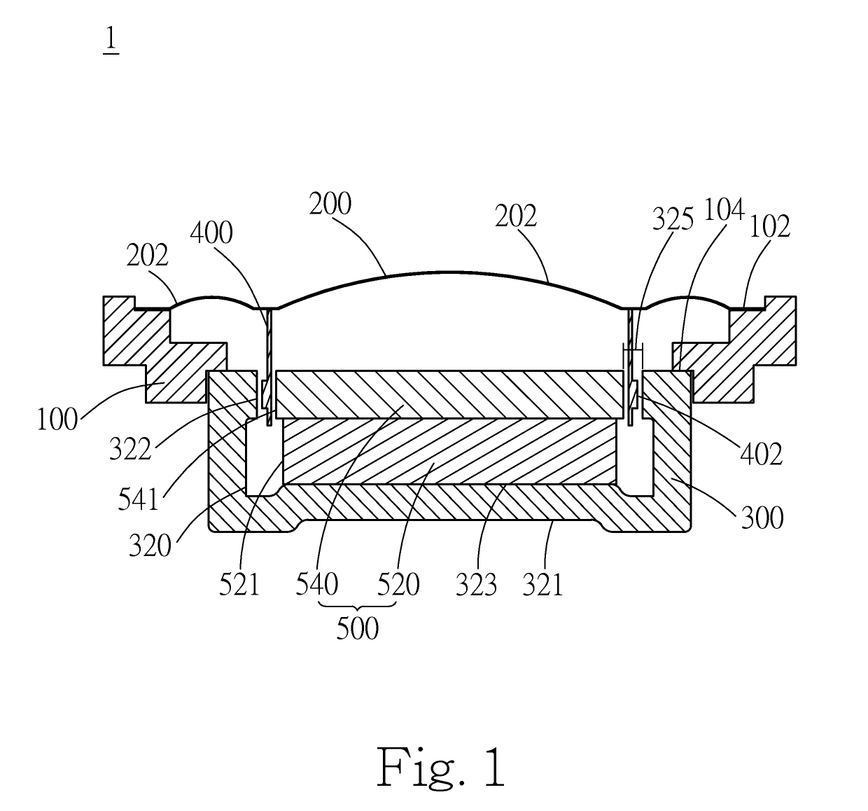

With reference to FIG. 1 for a structure of speaker driver according to a preferred embodiment of the present invention, the structure of speaker 1 includes a base 100, a drum paper 200, a yoke 300, a sound coil 400 and a magnetic unit 500.

The base 100 includes an upper combining portion 102 and a lower combining portion 104.

The drum paper 200 is configured to the upper combining portion 102. A plurality of camber 202 is formed from the center of the drum paper 200 to outside of the drum paper 200.

The yoke 300 is configured to the lower combining portion 104. An internal ring surface 320 of the yoke 300 includes a surface of first poly-magnet 322 and a surface of second poly-magnet 323. The surface of first poly-magnet 322 is closer to center of yoke 300 than the internal ring surface 320, the surface of second poly-magnet 323 rises along with the internal of yoke 300, a bottom of yoke 300 also correspondingly rises to the surface of second poly-magnet 323. Therefore, the thickness of surface of second poly-magnet 323 and the underside 321 are symmetric and equal.

The sound coil 400 is configured to an underside of drum paper 200 surroundingly, wherein, the sound coil 400 further includes a conductive coil 402.

The magnetic unit 500 includes a magnet 520 and a front piece 540. The front piece 540 is configured to above magnet 520, and the magnet 520 is configured to above the surface of second poly-magnet 323. Wherein, the front plate 540 is magnetic permeable. Furthermore, an external ring surface 541 of front piece 540 is more distant from center of front piece 540 than an external ring surface 521 of magnet 520.

In addition, a magnetic gap 325 is formed between the external ring surface 541 of front piece 540 and the surface of first poly-magnet 322 of the yoke for positioning the sound coil 400. Thus, performs by providing an electric power, the sound coil 400 generates a magnetic field, and performs perpendicular movements within the magnetic gap 325, thereby moving the plurality of camber 202 of drum paper 200. Due to the movement of sound coil 400, the camber 202 vibrates the air and generates sound.

It should be appreciated that the surface of first poly-magnet 322 and the front piece 540 forces the magnetic lines generated by sound coil 400 to integrate, thus enhancing the magnetic force (Webber) within the magnetic gap 325. On the other hand, the surface of second poly-magnet 323 and the underside 321 effectively reduces the magnetic flux (Gauss) loss during the perpendicular movements of the sound coil 400, thus preventing magnetic loss.

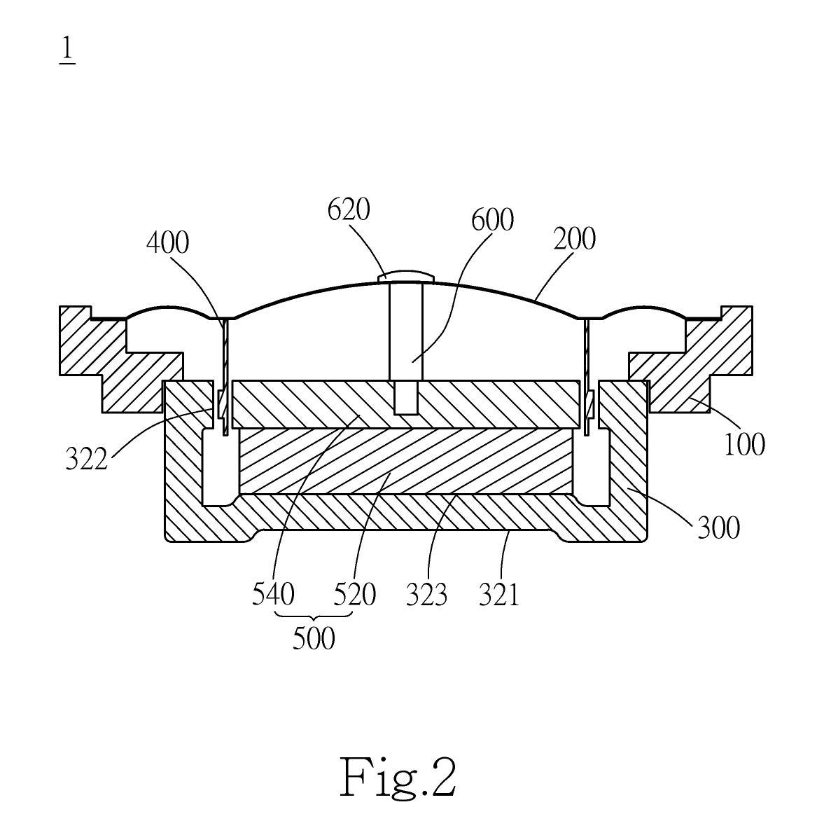

With reference to FIG. 2 for a structure of speaker driver according to another preferred embodiment of the present invention, the structure of speaker 1 further includes a supporting column 600.

One side of the supporting column 600 is locked by the front plate 540, and the other side of supporting column 600 is connected with the drum paper 200. The supporting column 600 enhances the stability of the sound coil 400 in perpendicular movements, thus preventing the sound coil 400 from colliding with the yoke 300 and the magnetic unit 500 and reducing the life time of sound coil 400. In addition, the supporting column 600 can either be stuck to the front plate 540 or be added adhesive when being locked by the front plate 540 to strengthen the stability of the two.

In addition, the supporting column 600 further include a dust cover 620, the dust cover 620 covers the drum paper 200 corresponded to the supporting column 600 for preventing the dust from entering into the structure of speaker 1.

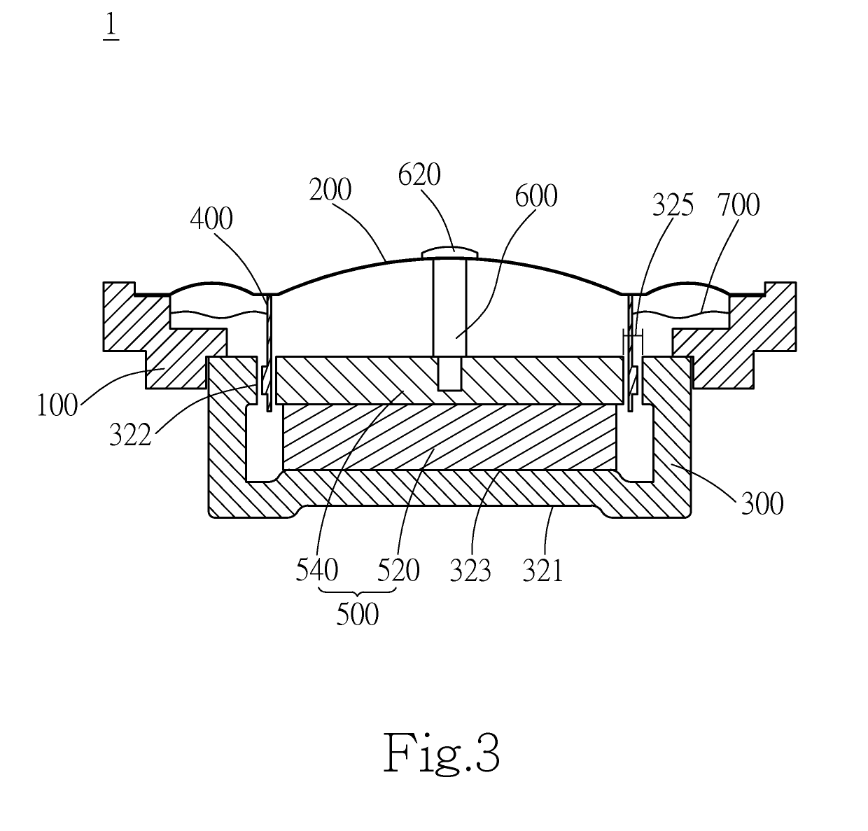

With reference to FIG. 3 for a structure of speaker driver according to another preferred embodiment of the present invention, the structure of speaker 1 further includes a wavy plate 700.

One side of wavy plate 700 is configured to the base 100, and the other side is configured to the sound coil 400. Wherein, the wavy plate 700 maintains the sound coil 400 at a right position within the magnetic gap 325, and enhances the stability of sound coil 400 in perpendicular movements, thus preventing the unexpected dust or an object from dropping into the yoke 300 and the magnetic unit 500.

Furthermore, the structure of speaker 1 could choice to also add the supporting column 600 for enhancing the stability of the sound coil 400, or not to add the supporting column 600, in this embodiment, the supporting column 600 is added.

The abovementioned embodiments are provided to illustrate the principles and exemplary methods of manufacturing or formation method of the present invention only. The scope of the present invention shall be defined by the claims recited hereafter, and any modifications or variations to the terms or wordings recited in the claims shall be considered as their relevant equivalence and are within the scope of the present invention. The scope of the present invention shall be determined by the content of the claims recited hereafter.

What is claimed is:

1. A structure of speaker driver, comprising:
a base, comprising an upper combining portion and a lower combining portion;
a drum paper, configured to the upper combining portion;
a yoke, configured to the lower combining portion;
a sound coil, configured to an underside of drum paper surroundingly; and
a magnetic unit, comprising a magnet and a front plate, the magnetic unit is configured to above the yoke;
wherein an internal ring surface of yoke comprising a surface of first poly-magnet and a surface of second poly-magnet, the surface of first poly-magnet is closer to center of yoke than the internal ring surface, the surface of second poly-magnet rises along with the internal of yoke, a bottom of yoke also correspondingly rises to the surface of second poly-magnet; an external ring surface of front piece is more distant from center of front piece than an external ring surface of magnet.

2. The structure of speaker driver as claim 1, wherein a magnetic gap is formed between the surface of first poly-magnet and the external ring surface of front plate.

3. The structure of speaker driver as claim 2, wherein the magnetic gap is configured to position the sound coil.

4. The structure of speaker driver as claim 1, wherein the sound coil further comprises an electrical conductive coil.

5. The structure of speaker driver as claim 1, wherein the front piece is magnetic permeable.

6. The structure of speaker driver as claim 1, further includes a supporting column, one side of supporting column locks the front plate, and the other side of supporting column is connected with the drum paper.

7. The structure of speaker driver as claim 6, wherein the supporting column further includes a dust cover, the dust cover covers with one side of the supporting column connected with the drum paper.

8. The structure of speaker driver as claim 1, further includes a wavy plate, one side of wavy plate is configured to the base, and the other side of wavy is configured to the sound coil.
